(19) United States
(12) Patent Application Publication
(10) Pub. No.: US 2022/0227098 A1
(43) Pub. Date: Jul. 21, 2022

(54) BIONIC NESTED STRUCTURE FIBER COMPOSITE MATERIAL AND PREPARATION METHOD THEREOF

(71) Applicant: JILIN UNIVERSITY, Changchun City (CN)

(72) Inventors: Zhiwu HAN, Changchun City (CN); Yujiao LI, Changchun City (CN); Shichao NIU, Changchun City (CN); Binjie ZHANG, Changchun City (CN); Qigang HAN, Changchun City (CN); Zhiyan ZHANG, Changchun City (CN); Yufei WANG, Changchun City (CN); Wenda SONG, Changchun City (CN); Xiaojing QIN, Changchun City (CN); Zhibin JIAO, Changchun City (CN); Hao XUE, Changchun City (CN); Changchao ZHANG, Changchun City (CN); Xiancun MENG, Changchun City (CN); Tao SUN, Changchun City (CN)

(21) Appl. No.: 17/579,090

(22) Filed: Jan. 19, 2022

(30) Foreign Application Priority Data
Jan. 21, 2021 (CN) 202110082622.3

(51) Int. Cl. B32B 5/26; B32B 5/02; B32B 3/10; B29C 70/44; B32B 5/12; D03D 25/00; D03D 15/242

(52) U.S. Cl. CPC B32B 5/263; B32B 5/024; B32B 3/10; B29C 70/443; B29K 2309/14; D03D 25/005; D03D 15/247; B32B 2262/105; B32B 5/12

(57) ABSTRACT

A bionic nested structure fiber composite material includes a first fiber resin layer and a second fiber resin layer which are arranged in parallel, the first fiber resin layer and the second fiber resin layer are formed by a fiber bundle infiltrated with resin, and a bonded fiber unit is arranged between the first fiber resin layer and the second fiber resin layer, the bonded fiber unit are evenly distributed in a radial direction and a weft direction, the bonded fiber unit includes an inner core layer bonded fiber bundle, a middle core layer bonded fiber bundle and an outer core layer bonded fiber bundle, and the bonded fiber unit is performed 3D integrated layer-by-layer inner and outer nesting-and-weaving to form bionic nested structure.

### CROSS-REFERENCES TO RELATED APPLICATIONS

This application claims priority to Chinese Patent Application No. 202110082622.3, filed on Jan. 21, 2021, the content of all of which is incorporated herein by reference.

### FIELD OF THE INVENTION

The present disclosure relates to the technical field of fiber 3D integrated woven basalt composite materials, and more particularly, to a bionic nested structure fiber composite material and a preparation method thereof.

### BACKGROUND

With the continuous development of industrial science, the comprehensive performance of materials, especially the ability to withstand damage under special conditions such as high temperature, high speed, and high load, are increasingly required. A design and a preparation of a new composite material having light weight, high strength, high fracture toughness, and damage resistance have become an important research direction in the field of materials.

Fiber composite laminates and 3D fiber integrated woven composite materials have been widely discussed and researched, and are gradually used in civil construction equipment, military construction, and transportation construction. The 3D (Three-dimensional) fiber integrated woven composite material with a flexible hollow core layer has a flexible structure design. The advantages of high performance, significant weight reduction, high mechanical resistance, and good short-term energy storage have attracted widespread attention. Among them, a design of the core hollow fiber plays a vital role, which can significantly improve and optimize its overall performance. However, in the integrated design of sandwich hollow fiber, although the core layer can greatly reduce the overall weight and improve the instantaneous energy storage performance, the loss of strength and rigidity it brings is also inevitable, and it is easy to cause local yield of the composite material. As a result, the structure produces large plastic deformation when the external force increases very small, which in turn causes the overall material to break and cause huge losses. Therefore, when taking advantage of the flexible sandwich layer, how to improve the overall yield strength and the fracture toughness is very important.

Therefore, the current technology needs to be improved and developed.

### BRIEF SUMMARY OF THE DISCLOSURE

One aspect of the present disclosure provides a bionic nested structure fiber composite material, the bionic nested structure fiber composite material includes a first fiber resin layer and a second fiber resin layer are arranged in parallel, the first fiber resin layer and the second fiber resin layer are formed by a fiber bundle infiltrated with resin, and a bonded fiber unit is arranged between the first fiber resin layer and the second fiber resin layer, the bonded fiber unit are evenly distributed in a radial direction and a weft direction, the bonded fiber unit includes an inner core layer bonded fiber bundle, a middle core layer bonded fiber bundle and an outer core layer bonded fiber bundle, and the bonded fiber unit is performed 3D integrated layer-by-layer inner and outer nesting-and-weaving to form bionic nested structure.

Another aspect of the present disclosure provides a method for preparing a bionic nested structure composite material, the method includes steps of performing a 3D integrated layer-by-layer inner and outer nesting-and-weaving on the inner core layer bonded fiber bundle, the middle core layer bonded fiber bundle and the outer core layer bonded fiber bundle to form a bionic nested structure, infiltrating the bionic nested structure with resin to form a fiber resin structure, the fiber resin structure is cured at a preset temperature in a vacuum to obtain a bionic nested structure fiber composite material.

Other aspects of the present disclosure can be understood by those skilled in the art in light of the description, the claims, and the drawings of the present disclosure.

### BRIEF DESCRIPTION OF THE DRAWINGS

In order to explain embodiments of the present disclosure or the technical solutions in the prior art more clearly, the following will briefly introduce the drawings that need to be used in the description of the embodiments or the prior art. Obviously, the drawings in the following description are only some embodiments described in the present disclosure. For those of ordinary skill in the art, other drawings can be obtained based on these drawings without innovative work.

FIG. 1 is a schematic diagram of an internal structure of a bionic nested structure fiber composite material according to the present disclosure.

FIG. 2 is an electronic scanning photograph of a fiber microstructure of a forewing of the oriental dragon louse according to the present disclosure.

FIG. 3 is a 3D scanning rendering diagram of the fiber microstructure of the forewing of the oriental dragon louse according to the present disclosure.

FIG. 4 is a 3D view of a core layer bonded fiber bundles of the 3D fiber composite material structure according to the present disclosure.

FIG. 5 is a schematic diagram of a radial cross-section fiber connection mode of the 3D fiber composite material structure according to the present disclosure.

FIG. 6 is a schematic diagram of an outer core layer bonded fiber bundle of FIG. 4.

FIG. 7 is a side view of a radial fiber connection of the core layer bonded fiber bundle in FIG. 4.

FIG. 8 is a top view of a fiber weaving of an upper and a lower skins of the 3D of fiber composite material structure according to the present disclosure.

FIG. 9 is a top view of an integral structure bonded fiber unit of the bionic nested structure of the fiber composite material structure according to the present disclosure.

FIG. 10 is a top view of a single radially bonded fiber unit in FIG. 9.

FIG. 11 is a schematic diagram of an orthogonal penetrating joint fiber unit of the bionic nested structure of the fiber composite material according to the present disclosure, which is connected up and down to the fiber bundle.

In the figure: 1. An inner core layer bonded fiber bundle, 2. A middle core layer bonded fiber bundle, 4. An outer core layer bonded fiber bundle, 5. A first fiber resin layer, 6. A second fiber resin layer.

### DETAILED DESCRIPTION OF EMBODIMENTS

In order to make the objectives, technical solutions, and advantages of the present disclosure clearer and clearer, the present disclosure will be further described in detail below with reference to the accompanying drawings and embodiments. It should be understood that the specific embodiments described here are only used to explain the present disclosure, but not used to limit the present disclosure.

A creature that has evolved over hundreds of billions of years-oriental dragon louse opened our minds: Oriental dragon louse can protect the body of the beetle and the flying wings under an elytra from damage by external factors. It is a lightweight biocomposite material with unique characteristics. The topological distribution of strength and optimized structural design have become a good bionic object for the structural design of lightweight, reliable, high-efficiency, energy-saving and easy-to-control space vehicle components and the optimal design of lightweight materials in the field of aerospace and deep space exploration. The interior of the forewing of the oriental dragon louse contains a dense black protein layer and a layer of chitin fibers. Its structural units are an ordered cavity-hollow column structure, and each structural unit is composed of 5-6 layers of columnar thin-walled tube fiber layers. It is nested inside and outside layer by layer. On the inner side of the dorsal and abdominal walls, chitin fibers are laminated and laid in parallel, the elytra hollow core layer, and the chitin fiber layers are laid spirally and cross-laid to form hollow columns and cavities, the chitin at the transition between the core layer and the dorsal and the transition of the qualitative fiber layer in abdominal walls.

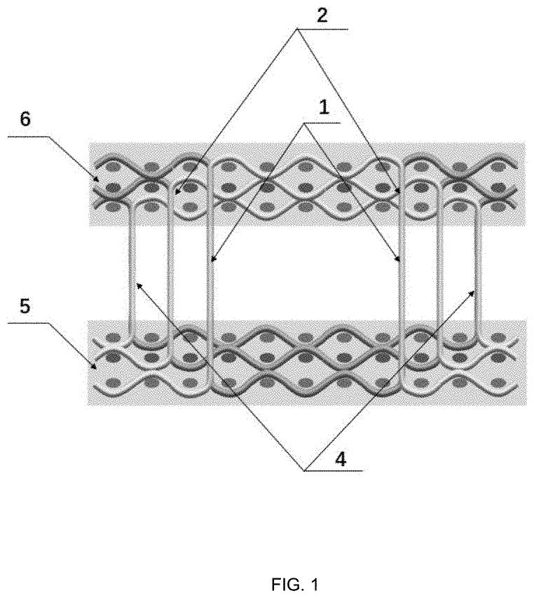

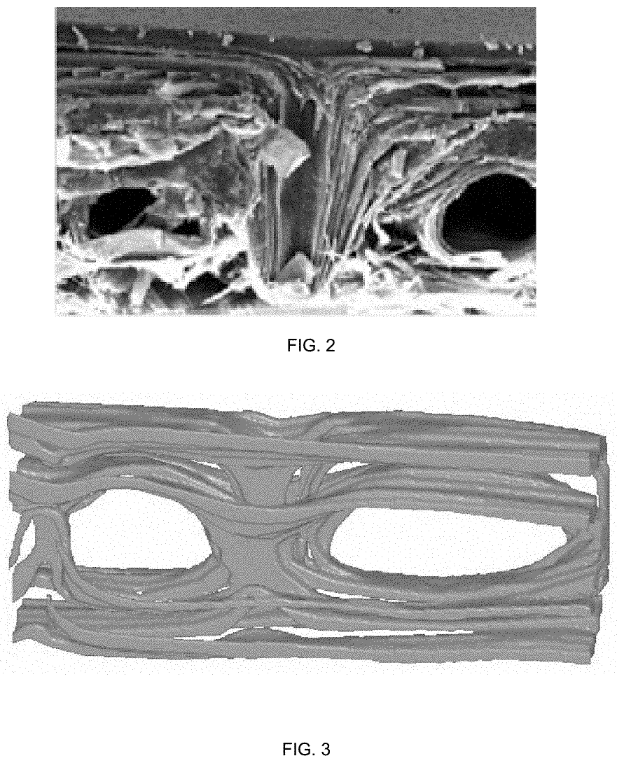

Inspired by the elytra structure of the oriental dragon louse, in order to solve the problem that traditional composite materials are prone to local yielding, which causes the structure to produce large plastic deformation when the external force increases very small, and then the overall material is broken, causing huge losses, the present disclosure provides a bionic nested structure fiber composite material aims to solve the problem that the existing engineering materials are difficult to meet the performance of the new composite material with light weight, high strength and damage resistance. The bionic nested structure fiber composite material is shown in FIG. 1, and includes first fiber resin layer 5 and second fiber resin layer 6 which are in parallel. The first fiber resin layer 5 and the second fiber resin layer 6 are made of fiber bundles infiltrated with resin. The material further includes a bonded fiber unit arranged between the first resin layer and the second resin layer, the bonded fiber unit is evenly distributed in the radial direction and the weft direction. The bonded fiber unit includes an inner core layer bonded fiber bundle 1, a middle core layer bonded fiber bundle 2 and an outer core layer bonded fiber bundle 4, the bonded fiber unit is performed 3D integrated layer-by-layer inner and outer nesting-and-weaving to form a bionic nested structure. During specific use, the bonded fiber unit is uniformly distributed in the radial direction and the weft direction, and the bonded fiber unit in both the weft direction and the radial direction are all performed the 3D integrated layer-by-layer inner and outer nesting-and-weaving to form the bionic nested structure, the bionic nested structure is similar to the microstructure of the forewing of the oriental dragon louse (as shown in FIGS. 2-3). The inner core layer bonded fiber bundle 1, the middle core layer bonded fiber bundle 2 and the outer core layer bonded fiber bundle 4 all having two symmetrical fiber bundles distributed alternately in the weft direction, and the inner core layer bonded fiber bundle 1 connects outer layer weft fiber bundles in both the first resin layer and the second resin layer, the middle core layer bonded fiber bundle 2 connects middle layer weft fiber bundles in both the first resin layer and the second resin layer, and the outer core layer bonded fiber bundle 4 connects inner layer weft fiber bundles in both the first resin layer and the second resin layer. In addition, the overall structure of the 3D fiber integrated connection can be changed by changing the number of fiber bundles contained in the bonded fiber unit, and the fiber bundles contained in the bonded fiber unit may be 3-8 bundles. Because the more fiber bundles in the bonded fiber unit, the vertical fiber bundle height in the bonded fiber unit will not change, but the thickness of the first fiber resin layer 5 and the second fiber resin layer 6 will increase. The ratio of the vertical fiber bundle height to the fiber resin layer decreases. The smaller the ratio is, the more it is not conducive to improving the specific strength and specific stiffness of the overall structure, but correspondingly, the structural integrity and stability can be improved. When the fiber bundles in the bonded fiber unit are 3-8, the structural integrity and stability can be guaranteed, and the specific strength and specific stiffness can also meet the performance requirements of the material. In practice, the fiber bundles in the upper and lower connection directions of the bonded fiber unit may be woven through orthogonal or corner connection, and the fiber bundles in the upper and lower connection directions of the bonded fiber unit are synchronously integrated forming. Compared with traditional laminated structure and sandwich structure, the structure of the present disclosure has the characteristics of light weight, good fracture toughness, high specific strength and specific rigidity. In practice, the bionic nested structure formed by the inner and outer nesting-and-weaving of the present disclosure can disperse the stress at the connection between the easily fractured core layer and the upper and the lower layers, thereby reducing stress concentration and avoiding local damage, the slip and separation between fibers, or between fibers and resin, the pull-out of the fibers, and the plastic deformation of the core fibers enable the material to absorb more energy and delay the occurrence of damage, increase the fracture toughness, have good damage resistance, and improve the energy absorption performance 25%-35%.

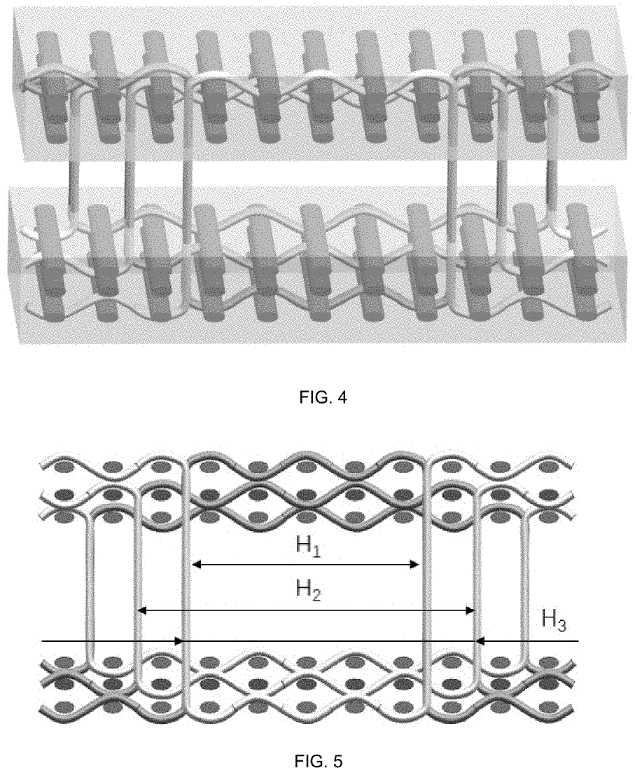

In an implementation method, the inner core layer bonded fiber bundle 1, the middle core layer bonded fiber bundle 2 and the outer core layer bonded fiber bundle 4 are all basalt fibers. In actual use, a basalt is used, because the basalt fiber is formed by high-speed drawing through a high-temperature resistant platinum-rhodium alloy drawing slip plate under high temperature melting. The fiber diameter is generally in the range of 10-20 μm. Due to the huge surface tension of basalt fiber, the cross-section shrinks to the smallest circle, the surface is relatively smooth, and the internal structure is compact. This fiber has high strength (equivalent to high-strength S glass fiber), fireproof (non-combustible), high temperature resistance (1100° C.), corrosion resistance, electrical insulation and other excellent properties. The production process has no additives, produces less waste, and pollutes the environment small, the product can be directly degraded in the environment after being discarded without any harm. It is a new type of inorganic environmentally friendly green high-performance fiber material. In this way, the bonded fiber unit composed of the inner core layer bonded fiber bundle 1, the middle core layer bonded fiber bundle 2 and the outer core layer bonded fiber bundle 4 can be used in the process of 3D integrated layer inner and outer nesting-and-weaving more smoothly, as shown in FIG. 4.

In another implementation method, the inner core layer bonded fiber bundle 1, the middle core layer bonded fiber bundle 2 and the outer core layer bonded fiber bundle 4 form a sandwich laminate structure. The oriental dragon louse forewing is a composite biomaterial with chitin fiber as the reinforcement phase and collagen protein as the matrix. The sandwich layered three-ply board is composed of a hollow cylinder of pier-like fibers connected to the back wall layer and the abdominal wall layer structure. In this embodiment, a sandwich layered three-ply structure is prepared according to the oriental dragon louse forewing structure design. The inner core layer bonded fiber bundle 1, the middle core layer bonded fiber bundle 2 and the outer core layer bonded fiber bundle 4 are formed by inner and outer nesting the fiber bundles layer-by-layer to form vertical fiber bundles and bonded fiber bundles. The first fiber resin layer 5 and the second fiber resin layer 6 are formed by infiltrating the bonded fiber bundles with resin. The fiber bundles constitute a three-ply structure with a sandwich layer. This structure can have light weight, high strength, high fracture toughness and damage resistance.

In one embodiment, the bionic nested structure forms a hollow layer. The first fiber resin layer 5 and the second fiber resin layer 6 which are formed after the bonded fiber bundles of the fiber unit are infiltrated with the resin are sandwiched with the vertical fiber bundles in a three-ply structure, the center of the three-ply structure is a hollow layer. The hollow layer reduces the mass of the overall structure, and the mass is concentratedly distributed at the far end of the neutral layer, so that the overall I-shaped structure increases the moment of inertia and section modulus, that is, the same material can exert maximum energy efficiency.

In one embodiment, the inner core layer bonded fiber bundle 1, the middle core layer bonded fiber bundle 2 and the outer core layer bonded fiber bundle 4 are in an interlaced connection. In practice, the upper and lower skins formed by the first fiber resin layer 5 and the second fiber resin layer 6 are woven by the bonded fiber bundles of the inner core layer bonded fiber bundle 1, the middle core layer bonded fiber bundle 2 and the outer core layer bonded fiber bundle 4 in the weft bonded fiber unit and the bonded fiber bundles of the inner core layer bonded fiber bundle 1, the middle core layer bonded fiber bundle 2 and the outer core layer bonded fiber bundle 4 in the radial bonded fiber unit. For example, the two inner core layer bonded fiber bundles 1 in the weft bonded fiber unit and the two inner core layer bonded fiber bundles 1 in the radial bonded fiber unit form a spatial “cross” structure, two middle core layer bonded fiber bundles 2 in the weft bonded fiber unit and two middle core layer bonded fiber bundles 2 in the radial bonded fiber unit form a spatial “cross” structure, two outer core layer bonded fiber bundles 4 in the weft bonded fiber unit and two outer core layer bonded fiber bundles 4 in the radial bonded fiber unit form a spatial “cross” structure. In this way, a bionic ‘fiber layer-by-layer nesting’ microstructure is realized at the same time, with two-phase reinforcement improve the stability and integrity of the overall structure, increase the friction between the fiber layers, and further improve the overall performance. In addition, the 3D integrated weaving technology, the thickness is determined by the number of fiber bundles in the bonded fiber unit, the more the bonded fiber units, the thicker, but the vertical heights of the inner core layer bonded fiber bundle 1, the middle core layer bonded fiber bundle 2 and the outer core layer bonded fiber bundle 4 remain unchanged. A fiber integrated woven connection and layered nesting make the woven structure better integrated and more stable, and improve the specific strength and fracture toughness of the structure. The specific strength is 5-15 times that of steel, and the weight is reduced by 15%-35% compared with traditional metal materials.

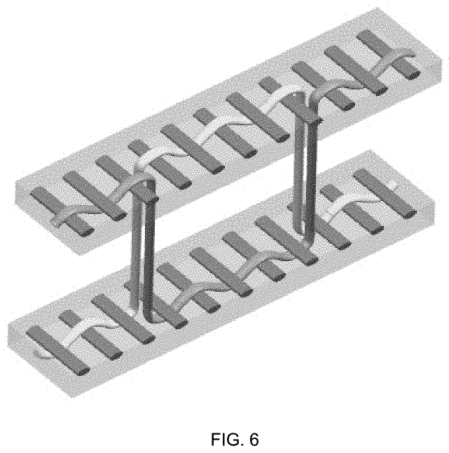

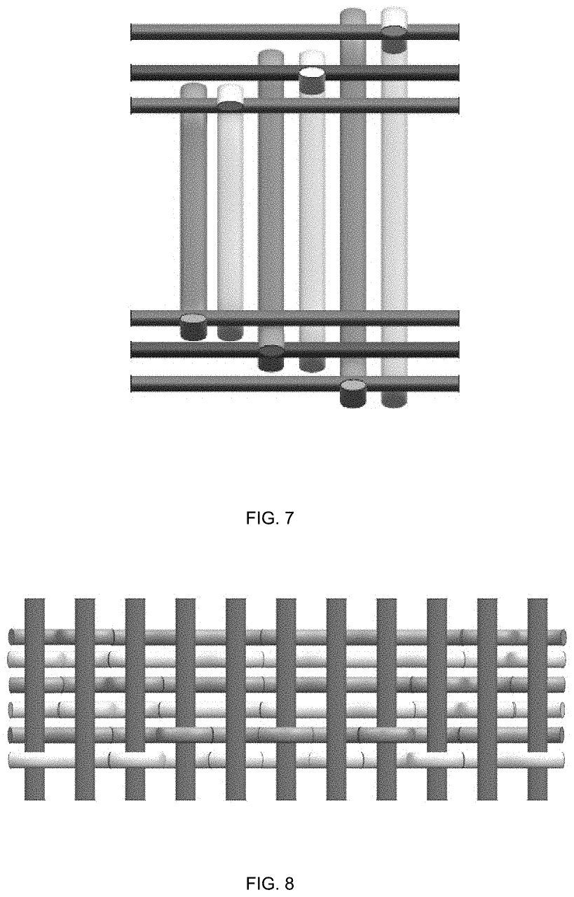

In an implementation method, the vertical fiber bundle heights of the inner core layer bonded fiber bundle 1, the middle core layer bonded fiber bundle 2 and the outer core layer bonded fiber bundle 4 are all different, and the vertical fiber bundle heights of the inner core layer bonded fiber bundle 1, the middle core layer bonded fiber bundle 2 and the outer core layer bonded fiber bundle 4 are all 3-10 mm. The inner core layer bonded fiber bundle 1 connects the outer layer weft fiber bundles in both the first resin layer and the second resin layer, and the middle core layer bonded fiber bundle 2 connects the middle layer weft fiber bundles in both the first resin layer and the second resin layer, the outer core layer bonded fiber bundles 4 connects the inner layer weft fiber bundles in both the first resin layer and the second resin layer, so the heights of the vertical fiber bundles in the inner core layer bonded fiber bundles 1, the middle core layer bonded fiber bundle 2 and the outer core layer bonded fiber bundle 4 are different. In practice, the heights can be set to 3˜10 mm. The directions of the inner core layer bonded fiber bundle 1, the middle core layer bonded fiber bundle 2 and the outer core layer bonded fiber bundle 4 in the bonded fiber unit are divided into a vertical direction and a bonded direction. The heights of the vertical fiber bundles in the inner core layer bonded fiber bundle 1, the middle core layer bonded fiber bundle 2 and the outer core layer bonded fiber bundle 4 are all determined after the prepreg being cured in a high-temperature vacuum tank. Since the fiber bundles may generate small ripples, the final height of the vertical fiber bundle and the bonded angle are determined by the state of the fiber during actual production. In another method, the distance between the inner core layer bonded fiber bundle 1 is H1 in FIG. 5, H1=(3-6)*h, and the distance between the middle core layer bonded fiber bundle 2 is H2 in FIG. 5. H2=H1+(2, 4, 6 . . ), the distance between the outer core layer bonded fiber bundle 4 is H3 in FIG. 5, H3=H2+(2, 4, 6 . . . ), and h is the distance between the weft fiber unit in the radial direction. If the surface density of the 3D fiber is large, the value of h is large, and if the surface density is small, the value of h is small, so H1, H2, and H3 are determined according to the actual areal density. FIG. 6 shows the outer core layer bonded fiber bundle of FIG. 4. FIG. 7 is a side view of the radial fiber connection at the end of the core layer connection of FIG. 4. FIG. 8 is a top view of the fiber weaving of the upper and lower skins of the 3D fiber composite material structure of the present disclosure.

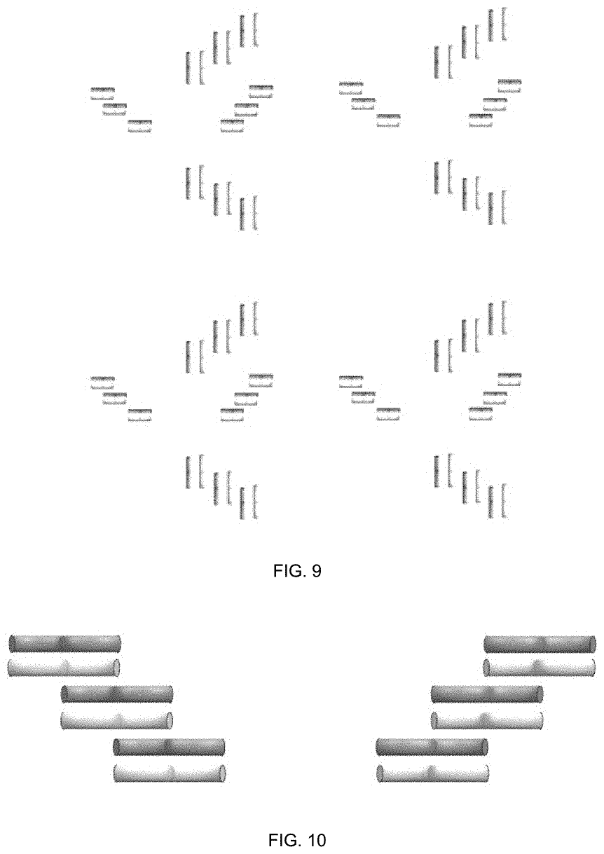

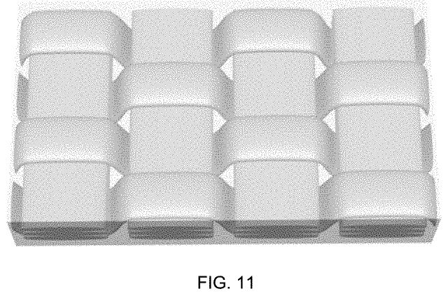

In another embodiment, the distribution of the bonded fiber units in both the radial direction and the weft direction is in a laid “8” shape (∞). The fiber bundles of the bonded fiber unit are equidistant in the weft direction. The heights of the vertical fiber bundles in the inner core layer bonded fiber bundle 1, the middle core layer bonded fiber bundle 2 and the outer core layer bonded fiber bundle 4 are different, and the height difference is the distance between the weft layer fiber bundles. The arrangement of the fiber bundles of the weft bonded fiber unit and the radial bonded fiber unit are the same. A radial bonded fiber unit and a weft bonded fiber unit form a spatial bonded fiber unit, as shown in FIG. 9, the spatial bonded units are uniformly arranged as a whole, and the spacing is the vertical direction fiber bundle height H1 of the inner core layer bonded fiber bundle 1. FIG. 10 is a top view of a single radially bonded fiber unit in FIG. 9. FIG. 11 is a schematic diagram of the bonding structure of the upper and lower bonded fiber bundles in the orthogonal penetrating bonded fiber unit of the bionic nested fiber composite structure of the present disclosure.

The embodiment of the present disclosure also provides a method for preparing a bionic nested structure fiber composite material, which includes the following steps:

S100. Performing a 3D integrated layer-by-layer inner and outer nesting-and-weaving on the inner core layer bonded fiber bundle, the middle core layer bonded fiber bundle and the outer core layer bonded fiber bundle to form a bionic nested structure.

S200. Infiltrating the bionic nested structure with resin to form a fiber resin structure.

S300. Curing the fiber resin structure at a preset temperature in a vacuum, to obtain a bionic nested structure fiber composite material.

In the embodiment, the design is first carried out through an improved rapier loom, and the inner core layer bonded fiber bundle, the middle core layer bonded fiber bundle and the outer core layer bonded fiber bundle are performed 3D integrated layer-by-layer inner and outer nesting-and-weaving to form the bionic nested structure, and the bionic nested structure is the prepreg. During the weaving process, the bonded fiber units in the first fiber resin layer and the second fiber resin layer are woven through an orthogonal penetrating or a corner penetrating, and the fiber bundles in the upper and lower bonding directions are synchronized and integrated, that is, the bonded fiber bundles in the weft bonded fiber unit and the bonded fiber bundles in the radial bonded fiber unit are synchronously integrally knitted and formed. The fiber of the bionic nested structure fiber composite material is a new type of inorganic environmentally friendly green high-performance fiber material, which is basalt fiber, and the resin is epoxy resin commonly used in industry. The fiber mass percentage is 30%-60% to ensure the specific strength, fracture toughness and integrity of the fiber composite material. The curing agent used in the curing treatment is polyetheramine or isophorone. The preset temperature is 100-300° C.

In summary, the present disclosure provides a bionic nested structure fiber composite material and a preparation method thereof, including: two parallel-arranged first fiber resin layer and second fiber resin layer, the first fiber resin layer and the second fiber resin layer is made of fiber bundles infiltrated with resin, and further including a bonded fiber unit disposed between the first resin layer and the second resin layer, the bonded fiber unit is evenly distributed in both radial and weft directions, the bonded fiber unit includes an inner core layer bonded fiber bundle, a middle core layer bonded fiber bundle and an outer core layer bonded fiber bundle, the bonded fiber unit is performed 3D integrated layer-by-layer inner and outer nesting-and-weaving to form a bionic nested structure. The biomimetic nested structure fiber composite material of the present disclosure is formed by performing 3D integrated layer-by-layer inner and outer nesting-and-weaving on the bonded fiber unit and then infiltrating the same with the resin to form a biomimetic 3D fiber 3D connection structure functional composite material, which is light in weight and broken, has good toughness, high specific strength and specific stiffness.

It should be understood that the application of the present disclosure is not limited to the above examples listed. Ordinary technical personnel in this field can improve or change the applications according to the above descriptions, all of these improvements and transforms should belong to the scope of protection in the appended claims of the present disclosure.

What is claimed is:

1. A bionic nested structure fiber composite material, comprising:
a first fiber resin layer and a second fiber resin layer which are arranged in parallel, the first fiber resin layer and the second fiber resin layer are formed by a fiber bundle infiltrated with resin, and a bonded fiber unit is arranged between the first fiber resin layer and the second fiber resin layer, the bonded fiber unit is evenly distributed in a radial direction and a weft direction, the bonded fiber unit includes an inner core layer bonded fiber bundle, a middle core layer bonded fiber bundle and an outer core layer bonded fiber bundle, and the bonded fiber unit is formed by a 3D integrated layer-by-layer inner and outer nesting-and-weaving to form bionic nested structure.

2. The bionic nested structure composite material according to claim 1, wherein the inner core layer bonded fiber bundle, the middle core layer bonded fiber bundle and the outer core layer bonded fiber bundle are basalt fiber.

3. The bionic nested structure fiber composite material according to claim 1, wherein the inner core layer bonded fiber bundle, the middle core layer bonded fiber bundle and the outer core layer bonded fiber bundle form a sandwich layered three-ply structure.

4. The bionic nested structure fiber composite material according to claim 1, wherein the bionic nested structure forms a hollow layer.

5. The bionic nested structure fiber composite material according to claim 1, wherein the inner core layer bonded fiber bundle, the middle core layer bonded fiber bundle and the outer core layer bonded fiber bundle are interleaved and connected.

6. The bionic nested structure fiber composite material according to claim 1, wherein heights of vertical fiber bundles in the inner core layer bonded fiber bundle, the middle core layer bonded fiber bundle and the outer core layer bonded fiber bundle are different, and the heights of vertical fiber bundles in the inner core layer bonded fiber bundle, the middle core layer bonded fiber bundle and the outer core layer bonded fiber bundle are 3˜10 mm respectively.

7. The bionic nested structure composite material according to claim 1, wherein the distribution of the bonded fiber units in the radial direction and the weft direction is in a laid “8” shape.

8. A method for preparing the bionic nested structure composite material according to claim 1, comprising steps of:
performing a 3D integrated layer-by-layer inner and outer nesting-and-weaving on the inner core layer bonded fiber bundle, the middle core layer bonded fiber bundle and the outer core layer bonded fiber bundle to form a bionic nested structure,
infiltrating the bionic nested structure with resin to form a fiber resin structure,
curing the fiber resin structure at a preset temperature in a vacuum to obtain a bionic nested structure fiber composite material.

9. The method according to claim 8, wherein a curing agent used in the curing treatment is polyetheramine or isophorone.

10. The method according to claim 8, wherein the preset temperature is 100 to 300° C.
